(19) United States
(12) Patent Application Publication
(10) Pub. No.: US 2025/0279409 A1
(43) Pub. Date: Sep. 4, 2025

(54) COMPOSITE ELECTRODE, A STRETCHABLE BATTERY AND METHOD THEREOF

(71) Applicant: Universidade De Coimbra, Coimbra (PT)

(72) Inventors: Mahmoud TAKAVOLI, Coimbra (PT); Pedro Filipe ALHAIS LOPES, Coimbra (PT); Guilherme CRUTO ALA DA COSTA, Coimbra (PT)

(73) Assignee: Universidade De Coimbra, Coimbra (PT)

(21) Appl. No.: 18/858,790

(22) PCT Filed: Apr. 24, 2023
(86) PCT No.: PCT/IB2023/054189

§ 371 Date: Oct. 22, 2024

(30) Foreign Application Priority Data
Apr. 22, 2022 (PT) 117926

(51) Int. Cl. H01M 4/134; H01M 4/02; H01M 4/04; H01M 4/38; H01M 4/62; H01M 4/66; H01M 10/0565; H01M 10/42; H01M 50/121

(52) U.S. Cl. CPC H01M 4/134; H01M 4/0404; H01M 4/0411; H01M 4/38; H01M 4/622; H01M 4/625; H01M 4/662; H01M 4/663; H01M 4/667; H01M 4/668; H01M 10/0565; H01M 10/4235; H01M 50/121; H01M 2004/021; H01M 2004/027; H01M 2004/028; H01M 2300/0082; H01M 2300/0085

(57) ABSTRACT

The present disclosure relates to a composite electrode comprising polymer with carbon particles percolated by gallium or a gallium-indium alloy, and a stretchable battery comprising: a cathode electrode comprising silver oxide and styrene-isoprene block copolymer (Ag2O-SIS) and a cathode current collector; an anode electrode comprising a gallium, carbon, and a polymer and an anode current collector; wherein each of the cathode current collector and the anode current collector comprise: a first current collector of a composite comprising liquid metal eutectic gallium-indium (EGaln), silver (Ag), and styrene-isoprene block copolymer (SIS); and a second current collector a second layer of carbon black (CB) and styrene-isoprene block copolymer (SIS). The disclosure also discloses a method to obtain said composite electrode and said stretchable battery.

### TECHNICAL FIELD

The present disclosure relates to a composite electrode, a stretchable battery, a method to obtain the electrode and method to obtain said stretchable battery.

### BACKGROUND

The next generation of soft and stretchable electronics is expected to have a transformative impact in various fields of applications, including health monitoring [1-5], robotics [6-8], e-textiles [9], flexible displays [10], and structural electronics [11,12]. These circuits are created using conductive composites [13], deterministic or serpentine structures [14, 15], and liquid metals [16], through screen printing, laser patterning and direct printing [16, 18]. Applications were demonstrated for wearable Electromyography (EMG) [19], Electrocardiography (ECG) [20], and Electroencephalography (EEG) [21]. However, most of the previous implementation are either tethered to an external power supply, or use a battery, which is the bulkiest rigid component in the patch. During the last few years, several solutions for harvesting energy for biomedical patches were studied. This includes flexible solar cells [22,23], microbial fuel cells and piezoelectric nanogenerators [25,26]. These are usually used in combination with supercapacitors for storage [27, 28]. However, printed batteries have at least one order of magnitude higher areal capacity than other thin-film energy harvesting/storage solutions, but carry one order of magnitude less areal power density compared to rigid coin-cell batteries. This shows both the potential of the printed batteries, and the importance of the further research, for the next generation of untethered biomonitoring patches, e-textiles, and other IoT devices.

In recent years, research on printable batteries has been directed towards novel architectures [29], and materials for current collectors [30], electrodes [31] and electrolytes [32]. Different fabrication mechanisms, like screen and stencil printing [33], laser patterning and spray coating [35], have also been the subject of numerous studies, resulting in demonstration of flexible [32, 36-39], stretchable [32-35], and thin-film batteries. A family of batteries being used more frequently in miniaturized devices are silver oxide-zinc (Ag₂O—Zn) batteries, with applications in hearing aids, smart watches and glucose monitors. This is mainly due to their high-power density [36], low self-discharge rate and low flammability when compared to lithium-ion batteries [32, 37]. In the last year, we presented a thin-film sticker with a printed Ag₂O—Zn battery over a thin tattoo paper (about 5 μm) [3], attaining a maximum capacity of 5.10 mAh cm⁻². In one recent work [44], an areal capacity of 12.5 mAh cm⁻² was obtained by construction of multi-layer thick electrodes, albeit stretchability was not shown.

Despite these promising results, the current techniques for fabrication of stretchable batteries involve many manual steps, and are not yet autonomous and scalable. There is an increasing interest in rapid fabrication of customized advanced electronics, IoT stickers, e-textile, and biomonitoring patches via digital printing. Digital printing eliminates the need for fabrication of stencils and manual deposition, and permits autonomous fabrication of customized systems.

The use of gallium as a negative electrode was already proposed in a patent three decades ago [45] (see US5462821A), by means of the redox reaction Ga—3e³⁻+6OH⁻↔GaO₃³⁻+3H₂O (FIG. 1B). Gallium presents interesting properties that have been recently explored in batteries [46]. Its self-healing abilities have already been applied in Lithium batteries (LiBs) [47,48] to enhance the cycle stability. Also, its high theoretical capacity attracted the applications of gallium-based anodes in batteries [49-51]. However, these recent studies on Ga-based batteries focused on conventional rigid batteries with bulk metal electrode.

The document US2021119213 discloses an electrode useful in an electrochemical cell. The electrode includes an electrochemically active material; an electrically conductive material; a solid ionically conductive polymer electrolyte; and a binder; wherein the binder is dispersed in an aqueous solution. US2021119213 also discloses a method of making the battery including the electrode.

Despite the rapid progress on soft and stretchable batteries, the current fabrication techniques involve manual disposition and stencil/screen printing.

These facts are disclosed in order to illustrate the technical problem addressed by the present disclosure.

### GENERAL DESCRIPTION

The present disclosure presents a digitally printable and stretchable, gallium-based composite comprising a printable gallium-carbon-SIS material as an anode electrode. SIS stands for styrene-isoprene block copolymers.

The present disclosure introduce for the first time a 3D-printed Ag—Ga (Silver-Gallium) battery through subsequent printing of four printable, and sinter-free composites: a stretchable Liquid Metal EGaln—Ag—SIS (Eutectic Gallium-Indium-Silver-Styrene-isoprene block copolymers) current collector, a Carbon-SIS (Carbon-Styrene-isoprene block copolymer) current collectors; Ag₂O—SIS (Silver Oxide-Styrene-isoprene block copolymer) cathode; and a novel Ga—C—SIS anode (Gallium-Carbon-Styrene-isoprene block copolymer). Being sinter-free results in faster printing, and compatibility with heat-sensitive substrates. Although the Ga—C—SIS is solid-like and non-smearing after printing, it creates a liquid interface after contacting with the electrolyte. This results in a self-feeding and self-aggregation mechanism that brings more gallium to the surface and delays the formation of the dead surface. The record-breaking areal capacity of about 19.4 mAh cm⁻², along with excellent stretchability (>130% Max. strain), makes the Ag—Ga (Silver-Gallium) battery an excellent alternative to Ag—Zn (Silver-Zinc) batteries. In an embodiment it was made an Ag electrode with an area 3 times bigger than gallium electrode, and the areal capacity per cm⁻² of gallium electrode was over 60 mAh. This is because the theoretical capacity of Ag is lower than Ga, and optimal ratio between gallium and silver electrode area is in the range of 3:1 to 4:1.

In an embodiment, surprisingly, digital printing results in 3× higher areal capacity compared to stencil printing, due to greater gallium exposure at the surface. By digital printing of several battery cells, and interconnects, it is customized the cell connection in serial/parallel for the desired voltage and current output. It is also demonstrated printing of sensors, electrodes, batteries, and interconnects on a biomonitoring e-textile for simultaneous monitoring of ECG, body temperature, and respiration.

The present disclosure relates to composite electrode comprising polymer with carbon particles percolated by gallium or a gallium-indium alloy.

In an embodiment, the carbon: gallium ratio in the polymer is 0.5% to 20%, preferably 1% to 5%, for percolating between gallium.

In an embodiment, the gallium is in form of microdroplets, ranging from 0.1 μm to 1000 μm.

Preferably the electrode is conductive after deposition without the need for thermal sintering. Preferably the viscosity is adjusted by adding a solvent of the polymer, to make it printable through digital printing, screen printing, extrusion printing, or stencil printing.

Preferably, the anode electrode comprises gallium carbon polymer composite, comprising gallium particles embedded in a polymer, further comprising carbon particles to percolate between gallium particles to render a sinter-free electrode. When the gallium is heated to over 30° C. degree, preferably to 50° C. it allows to be mixed with other components at liquid state. Preferably, the mixing of the gallium, carbon, and elastomer is performed through shear mixing, planetary mixing ultrasonic assisted mixing, or equivalent.

In an embodiment, the carbon: gallium ratio in the polymer is 0.5% to 20%, preferably 1% to 5%.

In an embodiment, the polymer is selected from a group of silicones, polyurethanes, styrene block copolymer, or mixtures thereof.

In an embodiment, the amount of polymer is 2-20% weight percent of a composite, preferably 4-9%.

In an embodiment, the polymer is styrene-isoprene-styrene block copolymer.

Preferably the polymer is soluble in a solvent.

Preferably the solvent percentage is adjusted to adjust the viscosity of the composite to make it printable through preferred deposition technique selected form rod coating, slot die coating, digital printing, screen printing, stencil printing, gravure printing, or equivalent.

Preferably the polymer is a stretchable elastomer, resulting in a stretchable electrode, and the polymer is reversible, meaning that it can be reversibly turn into a gel or solid, through exposure to the solvent.

In an embodiment, the carbon is in the form of nanoparticle or microparticles and the carbon is selected from carbon black, carbon nanowires, graphene quantum dots or graphene oxide.

Preferably, the percentage of carbon is adjusted to make the composite sinter-free, and conductive right after deposition.

In an embodiment, the gallium is embedded in the styrene-isoprene-styrene.

In an embodiment, the anode electrode comprises a gallium, carbon, and styrene-isoprene-styrene block copolymer (Ga—C—SIS) and an anode current collector.

In an embodiment, the composite electrode is a sinter-free electrode. Preferably is a sinter-free conductive electrode.

It is also disclosed an anode electrode comprising the electrode already described.

It is also disclosed a stretchable battery comprising: a cathode electrode comprising silver oxide and styrene-isoprene block copolymer (Ag₂O—SIS) and a cathode current collector; an anode electrode as described above and an anode current collector; wherein each of the cathode current collector and anode current collector comprise: a first current collector of a composite comprising liquid metal eutectic gallium-indium (EGaln), silver (Ag), and styrene-isoprene block copolymer (SIS); and a second current collector a second layer of carbon black (CB) and styrene-isoprene block copolymer (SIS).

Preferably the anode comprises a gallium, carbon, and styrene-isoprene block copolymer (Ga—C—SIS).

In an embodiment, a damaged battery can be repaired through exposure to the solvent, or solvent vapour that reconnects the damaged zone through reconnection of the polymer binder. The materials in the battery can be recycled by dissolving the soluble or the reversible polymer in the solvent, and collecting the embedded microparticles. Preferably, the battery is obtained by a sintered-free method.

In an embodiment, each of the electrodes is arranged over the respective current collector.

In an embodiment, the second current collector is arranged over the first collector for protecting the first current collector from chemical corrosion by an electrolyte.

In an embodiment, the printable battery further comprises an electrolyte.

In an embodiment, the electrolyte comprises a gel or a hydrogel selected from PAAM-Alginate or equivalent, soaked into the electrolyte.

In an embodiment, the electrolyte is KOH.

In an embodiment, the anode electrode is arranged such that when the anode electrode is arranged such that the Ga—C—SIS gallium particles in the composite self-feed to the surface of the electrode at interface with the electrolyte and aggregate to larger particles.

In an embodiment, each of the cathode current collector and the anode current collector and the anode and the cathode comprise an elastic binder.

In an embodiment, the elastic binder is selected from a list of silicones, polyurethane, block copolymers or equivalent elastomers.

In an embodiment, the ratio of eutectic gallium-indium (EGaln): silver (Ag): styrene-isoprene block copolymer (SIS) of the first current collector of each of the cathode current collector and anode current collector is 0.65:1:0.65.

In an embodiment, each first current collector and second current collector of the cathode and the anode, has a thickness from 10 to 400 μm, preferably 20 to 300 μm, preferably from 50 to 200 μm, more preferably from 90 μm to 130 μm.

In an embodiment, the thickness of each anode electrode and cathode electrode is from 50 to 1000 μm, preferably from 100 to 500 μm.

In an embodiment, the battery further comprises a film as a seal, preferably the film is selected from a list of thermoplastic polyurethane, Styrenic block copolymer, silicones or equivalent.

In an embodiment, the battery is printable, in particular the anode, the cathode and the respective current collectors are printable.

It is also disclosed an electronic circuit comprising stretchable conductive traces of a composite comprising liquid metal eutectic gallium-indium (EGaln), silver (Ag), and styrene-isoprene block copolymer (SIS), and the battery.

It is also disclosed a textile comprising the stretchable battery.

It is also disclosed a method for obtaining the electrode by adding of a block copolymer solution in a solvent, and carbon black with subsequent mixing; melting an amount of gallium and adding it to the mixture, and mixing. Preferably, by adding 10-20% (wt) of a Styrenic block copolymer solution in a solvent, and carbon black with subsequent mixing for 1-5 min at 500-5000 rpm; melting an amount of gallium and adding it to the mixture, and mixing for 1-5 min at 500-5000 rpm.

In an embodiment, the method further comprises the step of depositing the anode electrode over the second current collector of the anode current collector.

In an embodiment, the final ratio between carbon and gallium is 0.5% to 20%, preferably 1% to 5%.

In an embodiment, the deposition is performed by digital printing, extrusion printing, or 3D printing.

It is also disclosed a method to obtain the stretchable battery comprising the following steps:
obtaining the first current collector of each cathode current collector and anode current collector by mixing 20 wt % of styrene-isoprene solution in Toluene with silver flakes in 1:0.65 weight ratio for 3 min at the 2000 rpm and adding liquid metal eutectic gallium-indium and mixing for 3 min at 2000 rpm;
printing the first current collector of each cathode current collector and anode current collector in a substrate;
obtaining the second current collector of each cathode current collector and anode current collector by adding the carbon to 20% styrene-isoprene solution in 1:9 weight ratio, and mixing for 3 min at 2000 rpm, preferably the carbon is carbon black;
printing the second current collector of each cathode current collector and anode current collector an arrange over the first current collector;
obtaining the cathode electrode by adding carbon powder to 20% of styrene-isoprene solution, mixing for 3 min at 2000 rpm and adding Ag₂O with an additional mixing period of 3 min at 2000 rpm;
depositing the cathode electrode over the second current collector of the cathode current collector;
obtaining the anode electrode by adding 20% (wt) SIS solution to carbon black with subsequent mixing for 3 min at 2000 rpm; adding an amount of toluene and mixing at 2000 rpm; melting an amount of Ga and mixing for 3 min at 2000 rpm;
depositing the anode electrode over the second current collector of the anode current collector.

In an embodiment, the printing is digital printing, selected from extrusion printing, direct ink writing, and/or 3D printing.

In an embodiment the method comprises the step of encapsulating with a TPU film.

### BRIEF DESCRIPTION OF THE DRAWINGS

The following figures provide preferred embodiments for illustrating the disclosure and should not be seen as limiting the scope of invention.

FIG. 1: Schematic representation of an embodiment of a A) Preparation of the gallium-carbon-SIS digitally printable ink: i, ii) First CB is mixed with the SIS solution with the help of Toluene; iii, iv) Melted gallium 60OC is added, and mixed with the solution iv) Ga—C—SIS printable paste; B) When discharging the battery, gallium is converted to gallium (III) oxide whereas the silver oxide turns into metallic silver. The electrons flow from the anode to the cathode; C) Digitally printing a silver-gallium battery: i, vi) Extrusion printer depositing the materials ii, v) Printing the 1st CC; iii, vi) Printing the 2nd CC; iv) Printing the electrodes; vii) Placing the electrolyte; D) The role of carbon in the anode: i) Sheet resistance measurements of gallium electrodes with different CB:Ga ratio; ii) Schematic demonstrating the role of the CB in percolating the gallium particles e) Digitally printing 2 batteries with 6 cells each in parallel and in series. Each battery had 3 battery cells in parallel and 2 in series.

FIG. 2: Photographic representation of an embodiment of a a) First discharge curve in the silver-gallium battery; b) Voltage peaks displayed at different currents for a stencil printed battery and a digitally printed battery; c) Discharging a battery while stretching at the same time. The discharge current applied was 200 μA; d) Comparing capacity values of a stencil printed battery, a stretched battery and a digitally printed battery; e) Areal capacity, and maximum stretchability of state of the art works in stretchable batteries; f) Discharging the battery at open circuit. The battery took around 13 days to discharge; g) optical image comparing a stencil and a digitally printed gallium electrode: h) Battery's rechargeability: i) Battery performing 100 cycles at 0.4 mA cm⁻²; ii) magnified image from a subset of cycles in i.

FIG. 3: Illustration of results of SEM and EDS of the Gallium-Carbon-SIS electrodes. A) Fresh electrode B) Electrode after being in contact with the electrolyte C) After Discharging the battery D) After 100 charge and discharge cycles. In all images A, B, C, D: i) SE microscopy image; ii) color map of the gallium element intensity; iii) oxygen element intensity; iv) carbon element intensity.

FIG. 4: Suggested model for the Ga—C—SIS electrode; A) Before contacting the electrolyte (pristine electrode) B) After contacting with the electrolyte, forming a liquid aggregated interface C) After electrochemical cycling (KOH exposure).

FIG. 5: a) Schematic design of two multi-cell batteries connected in parallel and in series in a 3×2 arrangement. All of the layers where printed using the extrusion printer; b) Digitally printed silver gallium battery with the soft hydrogels lighting an LED; c) Biomonitoring wearable “Wow Belt” acquiring body temperature, respiration and heart monitoring; d) Prototype of the printed battery used for the WoW belt before integration into the textile and; e) after integration into the belt, providing 22 h autonomy.

### DETAILED DESCRIPTION

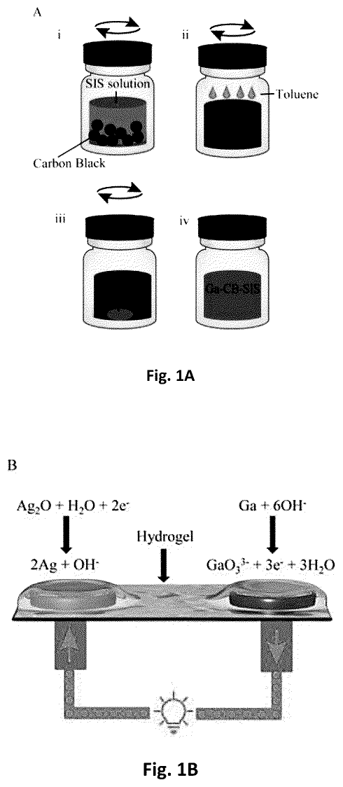

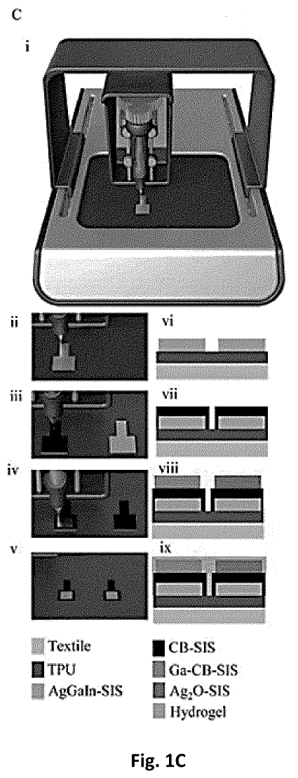

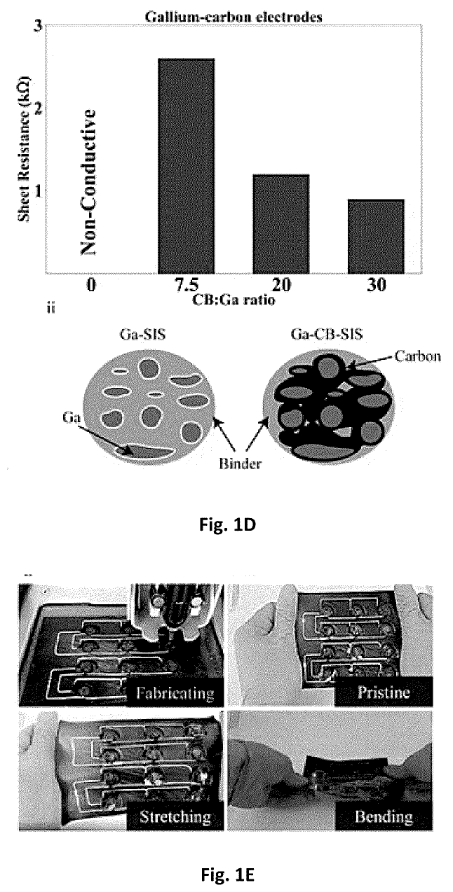

The present disclosure relates to a fully digitally printed stretchable Ag—Ga battery, through a combination of four digitally printable composites (FIG. 1). All composites are sinter-free, and the whole process is performed in the room temperature, making it compatible with a wide range of heat-sensitive substrates.

In an embodiment, the first step comprises printing a highly stretchable Liquid Metal (LM) composite as the first (and main) Current Collector (CC). This biphasic stretchable composite was recently introduced by the inventors [18], and is composed of Ag flakes (silver flakes), Eutectic Gallium Indium (EGaln), and Styrene-isoprene block copolymers (SIS). The ink is sinter-free, benefits from high conductivity, low gauge factor (0.9), stable behaviour over thousands of cycles, and can be stretched to 600%, without losing conductivity. Unlike the LM itself, the ink dries after deposition, and is non-smearing, allowing thus printing of subsequent layer over it.

In an embodiment, the second CC layer is made of Carbon Black (CB) and SIS. CB—SIS protects the first CC layer from chemical corrosion.

In an embodiment, the electrodes consisted of a digitally printable Ag₂O—SIS as cathode and of a novel printable gallium-carbon-SIS (Ga—C—SIS) as anode.

It is also disclosed a digitally printable gallium-carbon-SIS (Ga—C—SIS) material, as the anode electrode (FIG. 1A). The move from zinc (used in Ag₂O—Zn printed batteries) to gallium, is made because the tests showed that synthesizing a digitally printable Zn (zinc) composite proved to be very challenging. Several Zn composites were studied, with various types of Zn particles and flakes; however, it was not possible to obtain a stable digitally printable composite that exposes enough zinc particles to the surface of the electrode after the printing. In addition, when trying to increase the Zn in the Zn—SIS composite to more than about 40 wt %, the composite becomes very viscous, brittle, and powder-like, and therefore non printable. However, it is possible to synthesize a digitally printable Gallium-Carbon-SIS with 69.0 wt % of Gallium. As the gallium melts at 29° C., it is possible to mix a melted gallium (at above 30° C., but preferably at 50-60° C.) with a polymeric network in situ. The top-down technique allows adjusting the dimension of the gallium particles within the polymeric network, by adjusting the mixing time and speed.

Moreover, as due to low melting temperature, gallium metal can be mixed at liquid state with elastomers, this permits mixing a high percentage of metal (e.g. 80%-98%,) with elastomers. At such weight percentage, it is difficult or impossible to mix other metals such as zinc, because the composite becomes very high viscosity when mixing, which makes it difficult to mix. Besides, after curing, the composite becomes very brittle, and loses its elasticity. Addition of liquid gallium however, makes it easy to mix, and after deposition, the composite is malleable.

Note that after melting, gallium remains liquid even below its cooling temperature. This is because of the gallium super cooling effect. The naturally forming and ultrathin (3 nm) oxide layer around the gallium particles protect the internal liquid gallium from solidification. Therefore, gallium composite is usually a biphasic composite even at temperatures much lower than its melting point.

Unfortunately, mixing gallium with elastomers does not result in a conductive composite. Even at very high weight percentage of gallium, the composite is not conductive, as the elastomers do not permit percolating between the gallium droplets. This is due to the liquid and malleable nature of gallium, which unlike solid metals does not form a percolating network inside an elastomer. Therefore, addition of carbon particles or tubes is necessary to percolate between the gallium particles or droplets.

Although other solid metals could as well be used to percolate between gallium particles, for energy storage application, carbon is preferred due to its inertness when in contact with acidic or basic electrolyte. Carbon does not enter into reaction with the electrolyte. Moreover, carbon-elastomer network protects the gallium particles from extreme exposure to electrolyte, and increase the life of electrode.

In the present disclosure, a digitally printed battery shows a record-breaking maximum capacity of 19.39 mAh cm⁻², which is the best value shown for printed stretchable batteries.

In an embodiment, it is presented a characterization of the microstructure, electromechanical coupling, and electrochemical cycling of the battery.

Surprisingly, despite not being liquid at the room temperature, once in contact with the electrolyte, the Ga—C—SIS presents a liquid-like behaviour, which results in a self-feeding (i.e. bringing the underlying Ga particles to the surface), and self-aggregation (i.e. aggregation of adjacent gallium particles to each other) property. This property exposes more gallium to the electrolyte, and delays the formation of the dead surface, thus improving the overall areal capacity.

In general, liquid metal batteries are appealing due to their flexibility, self-healing, dendrite-free operation [46, 52] and formation of better conformal interface with the electrolyte, thus more efficient charge transfer. However, deposition/printing of a liquid electrode is challenging. Therefore, Ga—C—SIS provides an excellent alternative. In an embodiment, it is a printable paste during extrusion, turns into a non-smearing composite after deposition, and only creates a liquid interface when in contact with the electrolyte.

The present disclosure also presents examples of possible applications, including a digitally printed multi-cell stretchable battery, in which several battery cells are connected via printed stretchable traces, to a configuration which provides the desired output voltage and current.

In an embodiment, a wearable e-textile belt, with digitally printed sensors, interconnects, and batteries, for simultaneous acquisition and wireless communication, electrocardiogram (ECG), respiration rate, heart rate, and body temperature are presented.

In an embodiment, referring to FIG. 1A, Ga—C—SIS electrode is synthesized by mixing carbon black, in a SIS solution (preferably in Toluene) in a planetary mixer, followed by the addition of molten gallium at 60° C. and additional mixing. When melted, gallium acts similar to other Liquid Metals Embedded elastomers (LMEE) [53] synthesized by EGaln. Gallium particles are formed in situ during the mixing process, whose size can be controlled by adjusting the mixing time and speed. However, similar to the LMEEs, Ga—SIS is not conductive after deposition. The added carbon percolates between the gallium microparticles to make it a conductive electrode (FIGS. 1D-i,ii), as it will be later shown as well in microscopic analysis. Increasing the carbon to gallium ratio improves the conductivity of the electrodes. However, it reduces the active gallium content that participates in the redox reaction, which results in lower areal capacity. Therefore, in an embodiment, the CB:Ga ratio 7.5 was kept as the formulation for the electrode. As a result, the Ga—C—SIS composite is printable, sinter-free, and conductive.

In an embodiment, the Ag₂O—SIS electrode is prepared by first mixing carbon black for 1 to 10 minutes, preferably 3 minutes with SIS solution, followed by the addition of Ag₂O μ particles. CB:Ag₂O ratio is 1:1 to 1:10. In one embodiment, it was used CB:Ag₂O:SIS solution weight ratio: 0.4:1.6:2. FIG. 1B summarizes the chemical reaction in the Ag—Ga battery.

In an embodiment, regarding the current collectors, referring to FIG. 1C, the battery is composed of two CC layers. The first CC, Ag—EGaln—SIS, is prepared by mixing Ag flakes, EGaln liquid metal, and SIS Block CoPolymer (BCP) solution in a planetary centrifugal mixer (see methods). It is digitally printable, highly conductive (7.02×10⁵ S m⁻¹), and highly stretchable (>600%). This allows effective charge transfer and excellent stretchability of the battery without compromising its efficiency, thanks to the very low gauge factor (0.9) of this CC layer. As it will be shown in the applications section, the same material is also used for direct digital printing of the circuit interconnects, skin-interfacing electrodes, and sensors, allowing one run fabrication of the first layer of complex integrated circuits, at the same time with the battery CC. The second CC, is a Carbon-SIS composite layer that protects the first CC layer against chemical corrosion from the electrolyte. It also guarantees that the metals in the first CC do not participate in the redox reaction. All layers of the battery (current collectors and electrodes) contain the same polystyrene-polyisoprene-polystyrene (SIS), allowing the seamless integration of the layers, and an excellent overall stretchability. Although SIS is used here, other polymers such as Styrene-Ethylene-Butylene-Styrene Thermoplastic Elastomer (SEBS) ca replace SIS. Also other block copolymers, polyurethanes, or silicones may be used as the binder, however Styrenic block copolymers such as SIS and SEBS Provide an excellent adhesion to substrate, a highly elastic behaviour, and a reversible function. That means the polymer can be reversibly turn into a Gel or Solid, through exposure to the solvent. In on embodiment, we used this property to repair a cut battery by exposing it to the Toluene vapour. We also could recover the Gallium from the electrode, through dissolving the SIS containing electrode in toluene.

In order to compare the areal capacity of the battery based on fabrication techniques, in two embodiments the printing of Batteries was performed by stencil and digital printing. For stencil printing, a stencil mask was patterned using a CO₂ laser, followed by subsequent deposition of CC layers, and the electrodes.

In an embodiment, FIG. 1C shows all steps for the digital printing. Digital printing is performed using a desktop extrusion printer (Voltera V1). Compared to the stencil printing, digital printing is considerably simpler and more autonomous, as it eliminates the need for stencil preparation, manual deposition, and stencil removal which often results in damaged traces, and low resolution. It also allows higher resolution in printing (about 200 μm line and spacing), compared to about 1 mm resolution in stencil printing. After printing each layer, a new cartridge is inserted for the subsequent material. The first printed layer, Ag—EGaln—SIS, is used both as the CC of the battery, and for printing interconnects, sensors, and antenna over a polymeric film.

In an embodiment, for both printing mechanisms, a layer-by-layer deposition took place in the following order (FIGS. 1C-i-vii): First CC comprises Ag—EGaln—SIS; Second CC comprises a Carbon-SIS layer; the cathode comprises Ag₂O—SIS composite (cathode); and the anode comprises Ga—C—SIS (anode). Both (Ga—C—SIS) anode or Ag₂O—SIS (cathode) are deposited over the second CC i.e. CB-SIS. Viscosity of all four materials are optimized for digital printing, through modification of the composite, and adjusting the amount of solvent and metal fillers. The use of Ag₂O—SIS, rather than the Ag—SIS that was used in previous Ag—Zn battery, allows the battery to provide energy immediately after fabrication without charging, presenting an initial voltage of about 1.7 V.

In an embodiment, FIG. 1E, show an example of an array of digitally printed battery cells that can be bent, stretched, or twisted. Each layer of the printed material is from 10 to 400 μm, preferably 20 to 300 μm, preferably from 50 to 200 μm, more preferably 90 μm to 130 μm thick. The overall thickness of the 3 printed layers on each side is around 500 μm. The batteries were printed over an ultrathin Thermoplastic Polyurethane (TPU) substrate with thickness of 90 μm. This film partially melts, when subject to a temperature of about 150° C., which permits transferring the circuit, and the battery into the textile or other materials, using a heat transfer machine. Under high temperature, the melted adhesive fuses into the fibers of the textile, causing a seamless integration. The process is similar to what has been used in the garment industry to transfer graphic designs to the textile. The next step is to place the hydrogels electrolytes above the batteries. Finally, encapsulate and seal the battery and the printed circuit with another TPU film that is thermally transferred above the device, using the same technique.

In an embodiment, the production of Hydrogel Electrolyte is made as follows: although liquid electrolytes provide excellent charge transfer, a solid/gel electrolyte is preferred due to its higher mechanical stability. In an embodiment it is used a Polyacrylamide (PAAm)-alginate hydrogel as a tough, conductive, and stretchable hydrogel as the electrolyte. The hydrogel is submerged in a 35% KOH solution (Potassium hydroxide solution) for 24 hours, to allow ionic conductivity required for the charge transfer in the battery.

In an embodiment, the battery is sealed with a film, preferably a Thermoplastic Polyurethane. In an embodiment, after printing all electrodes, and placing the hydrogels, the battery should be sealed in order to avoid any leakage of the electrolyte. To seal the batteries, it was used a heat-transferable TPU thermoplastic polyurethane film, and seal its edges to the substrate (e.g. SIS, or another TPU film), using a hot iron. The heat-transferable TPU film is composed of a TPU and an adhesive that melts at the lower temperature than the film itself (150° C.). Therefore, when selectively applying heat using an iron, the edges around the electrode and hydrogel bond to each other, thus protecting the battery and the hydrogel.

After fabrication, the battery was subjected to electrochemical characterization. The characterization was performed using a homemade potentiostatic/galvanostatic (PGSTAT) based on an open source hardware [54], which allowed the characterization of up to 10 batteries at the same time.

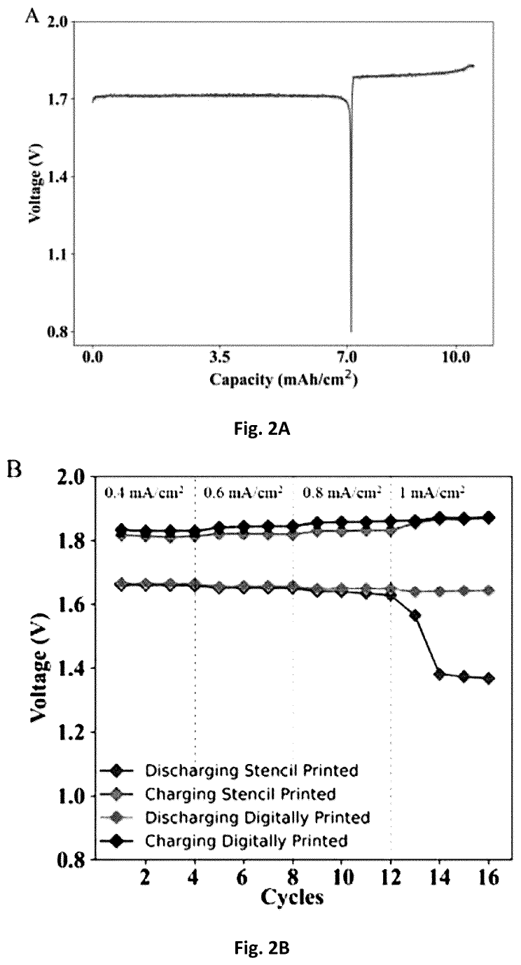

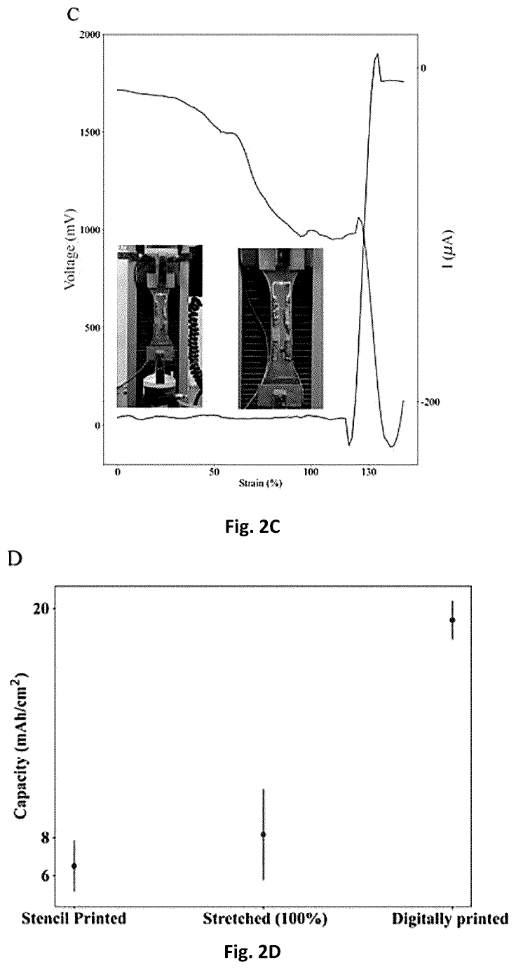

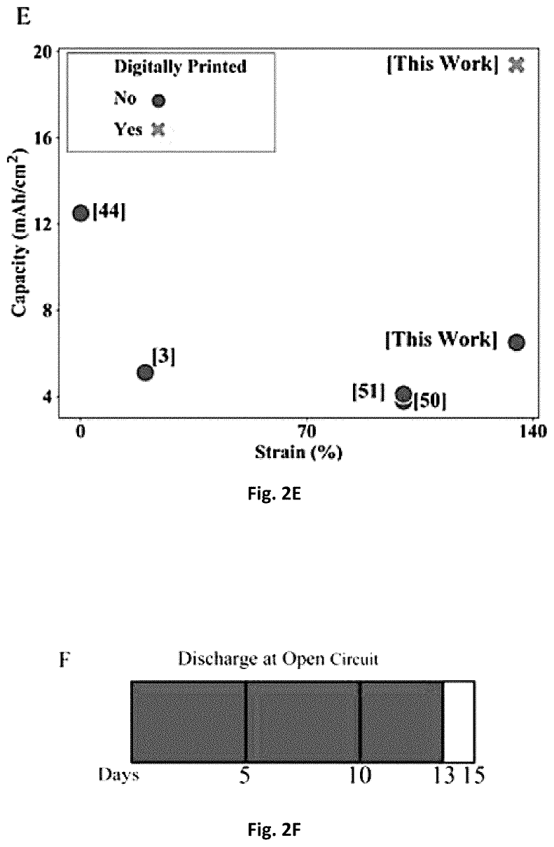

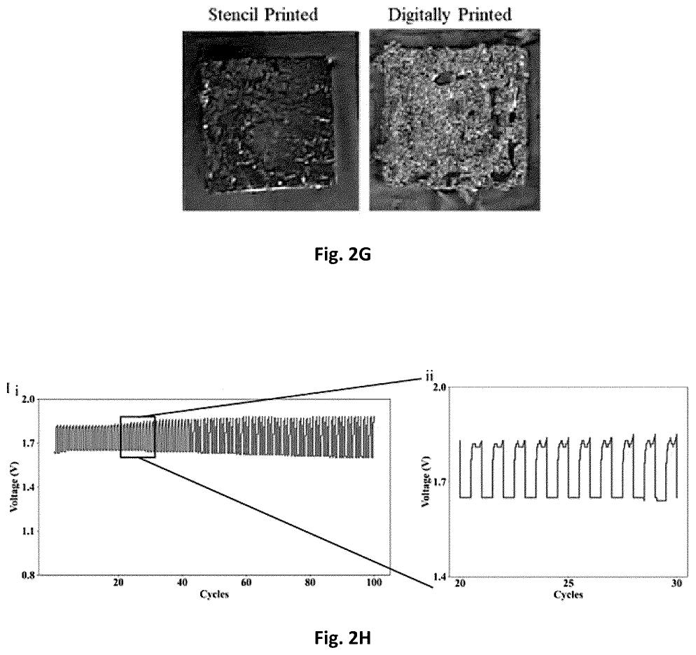

In an embodiment, FIG. 2A shows the discharge profile of the battery, revealing a stable plateau around 1.7 V. The flatness of the discharge voltage indicates the battery's stability while discharging. Referring to FIG. 2B, in order to compare the voltage values for both printing methods, the voltage peaks for different charge and discharge currents were obtained. Surprisingly, when increasing the current, the digitally printed battery shows a more stable behaviour compared to the stencil printed battery.

In an embodiment, the batteries were characterized under mechanical strain. First, it was analysed the devices performance while stretching and discharging at the same time.

FIG. 2C shows the battery's voltage remains above 0.8 V until an extraordinary value of about 130% strain (Average 133% for 3 batteries). Obtaining this high value is due to the high stretchability of all layers of the battery, including current collectors, electrodes, and hydrogel. Until 60% strain, it was not observed any significant alteration on the battery's internal resistance, demonstrated by the stability of its discharging voltage until this point.

In another experiment, five batteries were first stretched to 100% strain and then characterized. As shown in FIG. 2D, the battery areal capacity was slightly increased compared to pristine batteries, to an average value of about 8.15 mAh cm⁻². This phenomenon was also observed in Leal, C., Lopes, P.A.P.A., Serra, A.A., Coelho, J.F.J.J.F.J.J., De Almeida, A.T.A.T.A.T., and Tavakoli, M. (2020) [3], and seems to be related to the fact that during the strain, a better contact between the hydrogel and the electrodes is established, resulting in an increase in the quantity of active material that is exposed to the electrolyte.

It was also performed a comparation between digitally Printed Vs. Stencil Printed electrodes.

The initial experiments with the Ga—C—SIS electrode were through screen printed batteries, in order to replicate and compare the result to previous Ag—Zn batteries. Afterwards, digitally printed versions of the battery was made, which led to surprising results. Referring to FIG. 2D, it can be seen that the digital fabrication, results in a significant increase in the areal capacity of the batteries to (19.39 mAh cm⁻²). This is consistent with the improved behaviour for the digitally printed battery, observed in FIG. 2B. The reason for this difference is clearly observed in the FIG. 2G. The digitally printed electrode exposes considerably higher amount of gallium to the surface, compared to the stencil printed electrode. This seems to be related to the deposition procedure. During the stencil printing, a mechanical pressure should be applied to the material using a spatula. Considering that the gallium density is higher than the carbon, the applied pressure over the non-cured ink contributes to settling the gallium in the lower layers. When the deposition is performed by extrusion printing, the material keeps its homogenous distribution.

Additional SEM analysis from top surface of the stencil printed and digitally printed batteries, as well confirmed a better distribution of the gallium micro particles in the digitally printed electrode. Cross-sectional analysis showed that in stencil printed electrode, gallium particles are considerably larger, and accumulated at the bottom of the electrode.

Surprisingly, the Ga—C—SIS electrode presents an excellent combination of printability, conductivity, and chemical stability in the KOH electrolyte. The role of the SIS binder is to add the adhesion and stretchability properties to the composite. Besides, the viscosity of the SIS solution can be adjusted to the desired value for extrusion printing, by changing the amount of solvent.

Even though combination of Ga and SIS allows fabrication of a printable and adhesive electrode, this composition does not result in a conductive composite. Carbon black creates percolating networks between these particles, allowing thus electrical conductivity.

In an embodiment, FIG. 2E compares the areal capacity against maximum stretchability of the stencil printed, and digitally printed batteries against previous works on planar stretchable batteries. As a reference point, we also added a non-stretchable Ag₂O—Zn battery that presented a considerable areal capacity of 12.5 mAh cm⁻². As can be seen, it was obtained the highest value of maximum strain tolerance, and areal capacity. Besides, the results refer to a fully digitally printed stretchable battery. The Ag—Ga battery have a gravimetric capacity of 104.42 mA h g−1, when considering the full electrode mass, and of 162.5 mA h g−1, when considering only the mass of the metals in the composite (subtracting carbon and SIS). In the latter case, this is about 14% of the theoretical value for the Anode

Referring to FIG. 2F, self-discharge rate of the battery was studied by attaining the discharge profile at zero load. The battery presented a durability of at least 13 days after fabrication, which is about 3 times better than state of the art Ag—Zn battery, with a durability of less than 5 days. After 13 days, the battery was still presenting an operational voltage above 1V. FIG. 2H presents 100 electrochemical cycles performed by the battery, at a constant charging and discharging current of 0.4 mA/cm². The result is comparable to other LM based thin-film batteries [50].

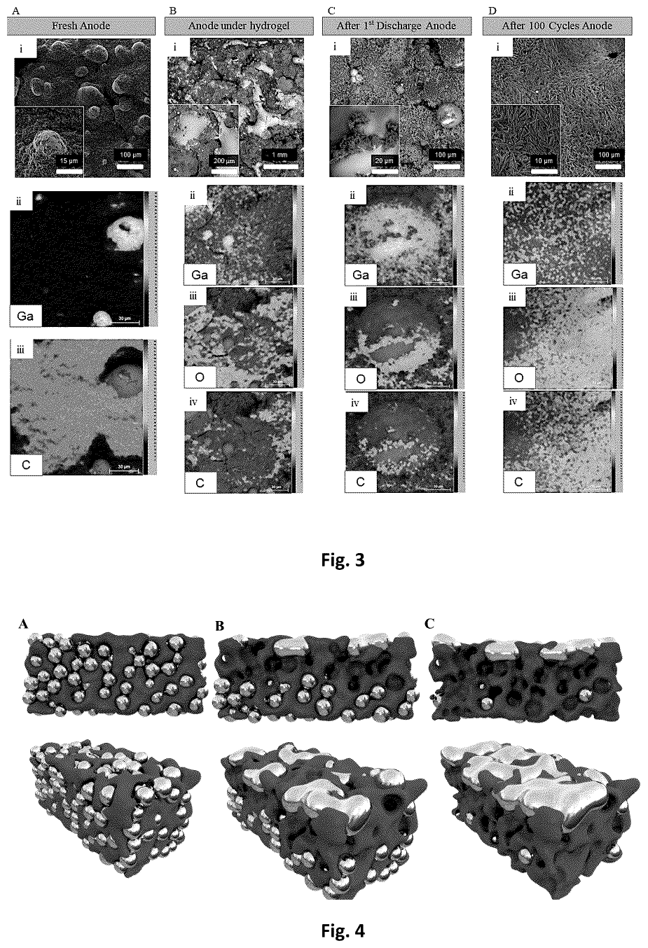

Scanning Electron Microscopy (SEM), and Energy-dispersive X-ray spectroscopy (EDS) analysis were performed in order to investigate the material and morphology of the electrodes over electrochemical cycles. FIG. 3 shows this evolution for the Anode electrode.

Generally, one of the reasons that printed batteries present lower capacity to the traditional bulk batteries is that in printed batteries, it is need to use composites rather than the bulk metal. Therefore, only a percentage of the metal is exposed to the surface, and some of the metal particles are buried in the underlying layers. Ga—C—SIS electrode seems to address this problem to some extent, by self-feeding more gallium to the surface. Comparing a fresh electrode (FIG. 3Ai), with an electrode exposed to the electrolyte (FIG. 3Bi), one can see that more gallium is exposed in the surface. Note that FIG. 3B, has 10× lower magnification, compared to 3A. After the contact with the electrolyte, gallium particles aggregate and cover a considerable amount of the electrode's surface (FIG. 3Bi). This presents a self-aggregation and self-feeding property that occurs only when the electrode is in contact with the electrolyte. This self-feeding mechanism improves the performance of the battery, by exposing more gallium at the surface, and delaying the formation of a metal-free dead surface, or formation of dendrites, as also shown recently in a liquid alloy Na—K battery [52]. The solubility of the gallium oxide thin film in the KOH solution, the low melting point of gallium (29° C.), and the generated heat during the Gallium-KOH reaction, contribute to formation of some liquid gallium droplets, that can move within the electrode, and aggregate with adjacent electrodes. It was analysed a Ga—C—SIS electrode before and after KOH exposure. It was shown that some gallium droplets are formed and made their way to the electrode surface. Note that in the assembled battery, rather than the liquid KOH solution, we use a solid hydrogel that is pressed to the electrode by the encapsulating film, and therefore these gallium droplets are restricted to the surface. In this way, the gallium spheres are not able to move freely within the electrolyte, and thus effectively contribute to the redox reaction.

In an embodiment, the self-aggregation of the gallium, and higher amount of gallium exposure after contact between the electrode to KOH are confirmed as well by the elemental intensity maps as well (FIGS. 3Aii, iii vs. FIGS. 3Bii,iii,iv). Comparing the gallium intensity map for the fresh electrode, and the electrode after being in contact with the KOH, one can see that in the latter case the surface of the electrode has considerably higher amount of gallium

In an embodiment, FIG. 3C shows the microstructure of the electrode after discharge and FIG. 3D shows the anode microstructure after 100 cycles. The needle-like structures are (GaO₃³⁻) that grow over the electrochemical cycles.

In an embodiment, FIG. 4 shows the suggested model for the changes on the Ga—C—SIS anode after the contact with the electrolyte. Right after the contact with KOH, the gallium oxide shell is dissolved, and some of the gallium particles come to the electrode's surface. As the top layer is restricted by the hydrogel and the encapsulating layer, some of these particles aggregate. At the same time, the porosity that is left in the microstructure due to the departure of some of these Ga particles, results in the exposure of the underlying gallium particles to the electrolyte, thus resulting in further particle aggregation and feeding to the top surface.

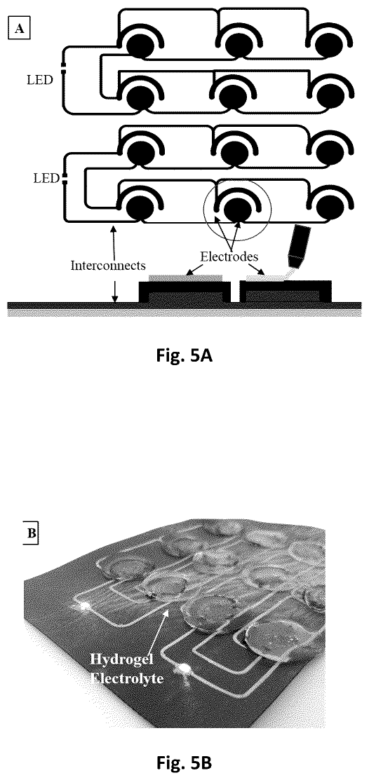

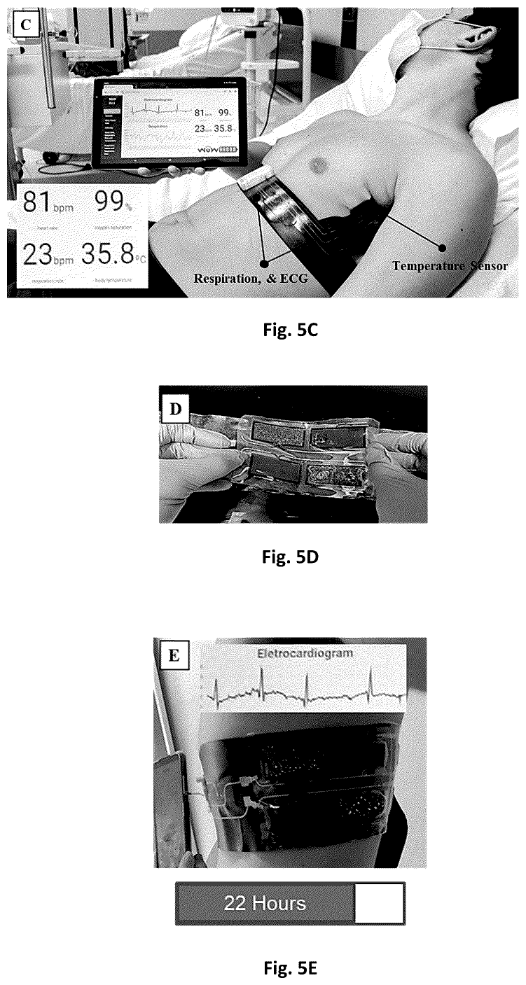

In order to show the scalable and autonomous fabrication of the printed Ag—Ga battery, and their respective applications, an embodiment was designed and printed 12 battery cells that are connected in series and parallel in a 3×2 format, to form two batteries (FIGS. 5A and B). All four composites are digitally printed using the extrusion printer. The first CC layer, the Ag—EGaln—SIS ink, is used for printing the interconnects between the batteries and the SMD LEDs, and the connection between the battery cells. In this way, it is possible to connect the battery cells in series, and parallel using printed lines, in order to adjust the output current and voltage for the required applications. This can be extended to printing electrodes, sensors, and antennas at the same time with the batteries. In an embodiment, FIGS. 5C, D and E show a printed battery, before and after integration into a wearable monitoring e-textile. The monitoring belt integrates printed electrodes for Electrocardiogram (ECG) monitoring, printed strain gauge for respiration monitoring, and a digital temperature sensor under the armpit. It was used the available space on the side of the belt for printing the battery. This solution provided enough energy for powering the belt for 22 hours for continuous data acquisition, and transition of clinical grade ECG data at 100 Hz via Bluetooth. As the desired input power for the biomonitoring board was >2V, two battery cells were series. However, putting the two batteries in series, results in a significant loss of efficiency, as it was discussed in other works [55]. As an alternative to this large battery in series (2*10 cm²), it is presented a significantly smaller battery with 3 cm² that could provide an autonomy of 9 h and 20 minutes, for ECG monitoring.

In an embodiment, a fully digitally printed stretchable battery that combines high areal capacity (19.4 mAh cm⁻²), and maximum strain tolerance of 130% is presented. The Ag—Ga battery is composed of four digitally printable and stretchable composites: Ag—EGaln—SIS first CC, the CB—SIS second CC, Ag₂O—SIS cathode electrode, and a novel Ga—C—SIS anode electrode. The Ga—C—SIS electrode, showed a combination of improved properties compared to zinc-SIS electrodes, including higher areal capacity, higher maximum strain tolerance, and the possibility of digital printing. Digitally printed batteries through extrusion deposition, showed considerably higher areal capacitance, and higher stability to electrochemical cycles compared to the stencil printed version of the battery with the same material composites. It can be seen that the digital printing exposes higher amount of gallium to the surface of the electrode compared to the stencil printing, thus resulting in significantly improved areal capacity, and electrochemical cycling.

In an embodiment, Ga—C—SIS electrode microstructure was analysed through optical and electronic microscopy, as well as EDS elemental mapping. Results showed that exposure of the electrode to KOH containing hydrogel electrode, results in formation of liquid gallium droplets, thus resulting in self-feeding, and self-aggregation of small gallium particles from the underlying surfaces into larger aggregates, thus improving the performance of the battery. This is due to the fact that underlying gallium particles can make their way into the surface of the electrode, which is not possible with other composites, such as Zn—SIS. The battery showed an open circuit discharge that is × higher than the similar battery with zinc anode electrode. In addition, the Ga—C—SIS electrode contains 69 wt % of gallium, and is still a homogenous and digitally printable composite. In comparison, several attempt to digitally print Zn—SIS electrode, with over 40 wt %. percentage zinc content has failed, due to formation of a very brittle and non-uniform composite. This should be as well a factor contributing to the excellent areal capacity of the Ag—Ga battery.

In an embodiment, the same electrolyte was used for both electrodes, without any separator.

In an embodiment, additives on the electrodes, or electrolytes that typically further improve the battery's performance can be used.

Some applications of integrated printed and stretchable electronics systems, in which electrodes, sensors, and interconnects are printed along with the first CC layer of the battery can be produced. This allows tailor making the required voltage and current of the battery to be adjusted to the desired values. An application of biomonitoring e-textile with a printed AG—Ga battery, to acquire and transmit clinical grade ECG data at 100 Hz via Bluetooth, with an energy autonomy of 22 hours was obtained.

All materials were used as received except when otherwise specified. Gallium and indium were order from Rotometals and Nova Elements. EGaln was made by melting and mixing 75.5 wt % of Ga and 24.5 wt % of In at 250° C. for 24 hours. Silver Flakes 071 were ordered from Technic, Inc. Silver flakes have a particle size of >5 μm. Carbon Black from AlfaAesar (45527). Polystyrene-block-polyisoprene-block-polystyrene (SIS) 14% styrene was ordered from AlfaAesar. Silver(I) oxide, 99+% (metals basis) was ordered from AlfaAesar(11407). Sodium alginate, Methylenbisacrylamide (BIS), Acrylamide, Irgacure and Calcium Sulfate were ordered from Sigma-Aldrich.

Thinky ARE-250 was used as the mixer. For the stencil printing, all plastic stencils were cut using a CO₂ laser cutter (VLS3.50). All digitally printed batteries were fabricated using Voltera printer.

In an embodiment, Ag—In—Ga—SIS (1st CC) preparation comprised the following steps: 20 wt % SIS solution in Toluene was prepared using the Thinky mixer. The solution was then mixed with Ag flakes in 1:0.65 weight ratio for 3 min at the 2000 rpm. Then, EGaln was added afterwards, and mixed for 3 min at 2000 rpm. Mixing ratio per weight was Ag:EGaln:SIS solution: 1:0.65:0.65.

In an embodiment, CB-SIS (2^{nd} CC) preparation comprised the following steps: CB was added to 20% SIS solution in 1:9 weight ratio, and mixed for 3 min at 2000 rpm.

In an embodiment, Ag₂O SIS Cathode Electrode preparation comprised the following steps: CB powder were added to 20% SIS solution, and mixed for 3 min at 2000 rpm. Ag₂O was added, with an additional mixing period of 3 min at 2000 rpm. CB: Ag₂O: SIS solution weight ratio: 0.4:1.6:2.

In an embodiment, Ga—C—SIS Anode electrode preparation comprised the following steps: The Ga—C—SIS electrode was prepared by adding 2 g of the 20% (wt) SIS solution to 0.6 g of CB with subsequent mixing for 3 min at 2000 rpm. Afterwards, 1 g of toluene was added to the previous mixture, followed by a 20 mins mixing at 2000 rpm. Lastly, 8 g of Ga was melted and added and mixed for 3 min at 2000 rpm. At the time of addition, Gallium temperature was 60° C.

In an embodiment Electrode Assembly via Stencil Printing comprised the following steps: a stencil was patterned to the desired shape over a plastic film using a CO₂ laser (Universal). A TPU film was transferred to a textile, using a heat press. Ag—In—Ga—SIS ink was deposited using the stencil and left to dry for one hour. Then a layer of CB—SIS was deposited over. The active electrodes were then deposited using a stencil, from which a 1 cm² square was cut.

In an embodiment electrode assembly via digital printing comprised the following steps: The digitally printed batteries were fabricated in the same order, but using a digital printer (Voltera V1). After printing each layer, the material cartridge was changed to the subsequent material. When using soft substrates, they should be attached to the substrate using an adhesive film (for instance double side adhesive). Prints were done using nozzles of 200 μm or 250 μm orifice.

In an embodiment, the morphological and microstructural behaviour of the composites were characterized by scanning electron microscopy (SEM) equipped with Energy Dispersive X-ray Spectroscopy (EDX) and mapping (Bruker Nano GmbH Berlin, Germany Esprit 1.9 and Detector type: XFlash 410).

In an embodiment, the hydrogel electrolyte was same as disclosed in [3]. 0.732 g of sodium alginate, 0.006 g of BIS and 4.5 g of Acrylamide were dissolved in 30 mL of Water. Afterwards the solution was degassed, and 20 mL were transferred to a syringe. 0.0492 g of Irgacure and 0.0646 g of Calcium Sulfate were placed in a different syringe with 1 mL of Water. With a syringe adapter, the content of both syringes was mixed. Casting on a glass was made to cure it in UV light for around 3 h. Once cured, the hydrogel was placed in a 35% (wt) KOH solution for 24 hours.

In an embodiment, integration of the printed battery on the belt was assisted via a transfer method, using Transfer Tattoo Paper (TTP). The TTP was, firstly, attached to the top of the TPU, gently pressed and peeled off right after, leaving a layer of glue on its surface. Next, the printed battery was put over this layer interfacing the belt. Finally, the hydrogel was placed on top of the electrodes and a layer of tegaderm film (3M) was used to seal the battery. Terminals of the battery were interfaced with the printed interconnects using the same Ag—EGaln—SIS ink. In this example, the printed circuit and battery had to be printed separately in two runs, due to the fact that circuit with the battery was larger than the printer working area.

Average and standard deviation in FIG. 2G is based on 3 samples, and were calculated using Excel software.

The term “comprising” whenever used in this document is intended to indicate the presence of stated features, integers, steps, components, but not to preclude the presence or addition of one or more other features, integers, steps, components or groups thereof.

The disclosure should not be seen in any way restricted to the embodiments described and a person with ordinary skill in the art will foresee many possibilities to modifications thereof. The above described embodiments are combinable.

The following claims further set out particular embodiments of the disclosure.

### References

1. Alberto, J., Leal, C., Fernandes, C., Lopes, P.A., Paisana, H., de Almeida, A.T., and Tavakoli, M. (2020). Fully Untethered Battery-free Biomonitoring Electronic Tattoo with Wireless Energy Harvesting. Sci. Rep.
2. Kim, D.H. (2011). Epidermal electronics (Science (838)). Science (80-.). 333, 1703.
3. Leal, C., Lopes, P.A.P.A., Serra, A.A., Coelho, J.F.J.J.F.J.J., De Almeida, A.T.A.T.A.T., and Tavakoli, M. (2020). Untethered Disposable Health Monitoring Electronic Patches with an Integrated Ag2O—Zn Battery, a AgInGa Current Collector, and Hydrogel Electrodes. ACS Appl. Mater. Interfaces 12, 3407-3414.
4. Lopes, P.A., Vaz Gomes, D., Green Marques, D., Faia, P., Góis, J., Patrício, T.F., Coelho, J., Serra, A., de Almeida, A.T., Majidi, C., et al. (2019). Soft Bioelectronic Stickers: Selection and Evaluation of Skin-Interfacing Electrodes. Adv. Healthc. Mater. 8, 1900234.
5. Carvalho, F.M., Lopes, P., Carneiro, M., Serra, A., Coelho, J., de Almeida, A.T., and Tavakoli, M. (2020). Nondrying, Sticky Hydrogels for the Next Generation of High-Resolution Conformable Bioelectronics. ACS Appl. Electron. Mater.
6. Guo, S.Z., Qiu, K., Meng, F., Park, S.H., and McAlpine, M.C. (2017). 3D Printed Stretchable Tactile Sensors. Adv. Mater. 29, 1-8.
7. Rocha, R.P., Lopes, P.A., de Almeida, A.T., Tavakoli, M., and Majidi, C. (2018). Fabrication and characterization of bending and pressure sensors for a soft prosthetic hand. J. Micromechanics Microengineering 28, 034001.
8. Rocha, R., Lopes, P., De Almeida, A.T., Tavakoli, M., and Majidi, C. (2017). Soft-matter sensor for proximity, tactile and pressure detection. In IEEE International Conference on Intelligent Robots and Systems (Institute of Electrical and Electronics Engineers Inc.), pp. 3734-3738.
9. Majumder, S., Mondal, T., and Deen, M. (2017). Wearable Sensors for Remote Health Monitoring. Sensors 17, 130.
10. Yoon, J., Joo, Y., Lee, B., Oh, E., Cho, H., and Hong, Y. (2018). Stretchable active-matrix light-emitting diode array using printed electric components on plastic and elastomer hybrid substrate. Dig. Tech. Pap.-SID Int. Symp. 49, 1925-1927.
11. Tavakoli, M., Malakooti, M.H., Paisana, H., Ohm, Y., Green Marques, D., Alhais Lopes, P., Piedade, A.P.A.P., de Almeida, A.T.A.T., and Majidi, C. (2018). EGaln-Assisted Room-Temperature Sintering of Silver Nanoparticles for Stretchable, Inkjet-Printed, Thin-Film Electronics. Adv. Mater. 30, 1-7.
12. Lopes, P.A., Paisana, H., Almeida, A.T., Majidi, C., and Tavakoli, M. (2018). Hydroprinted Electronics: Ultrathin Stretchable Ag-In-Ga E-Skin for Bioelectronics & Human-Machine Interaction. ACS Appl. Mater. Interfaces 10, 38760-38768.
13. Larmagnac, A., Eggenberger, S., Janossy, H., and Vörös, J. (2014). Stretchable electronics based on Ag-PDMS composites. Sci. Rep. 4, 1-7.
14. Li, S., Han, M., Rogers, J.A., Zhang, Y., Huang, Y., and Wang, H. (2019). Mechanics of buckled serpentine structures formed via mechanics-guided, deterministic three-dimensional assembly. J. Mech. Phys. Solids.
15. Yokota, T., Zalar, P., Kaltenbrunner, M., Jinno, H., Matsuhisa, N., Kitanosako, H., Tachibana, Y., Yukita, W., Koizumi, M., and Someya, T. (2016). Ultraflexible organic photonic skin. Sci. Adv. 2, e1501856.
16. Lopes, P.A., Fernandes, D.F., Silva, A.F., Marques, D.G., De Almeida, A.T., Majidi, C., and Tavakoli, M. (2021). Bi-Phasic Ag-In-Ga-Embedded Elastomer Inks for Digitally Printed, Ultra-Stretchable, Multi-layer Electronics. ACS Appl. Mater. Interfaces 13, 14552-14561.
17. Lu, T., Markvicka, E.J., Jin, Y., and Majidi, C. (2017). Soft-Matter Printed Circuit Board with UV Laser Micropatterning. ACS Appl. Mater. Interfaces 9, 22055-22062.
18. Silva, A.F., Paisana, H., Fernandes, T., Góis, J., Serra, A., Coelho, J.F.J., de Almeida, A.T., Majidi, C., and Tavakoli, M. High Resolution Soft and Stretchable Circuits with PVA/Liquid-Metal Mediated Printing. Adv. Mater. Technol., 2000343.
19. Ferrari, L.M., Sudha, S., Tarantino, S., Esposti, R., Bolzoni, F., Cavallari, P., Cipriani, C., Mattoli, V., and Greco, F. (2018). Ultraconformable Temporary Tattoo Electrodes for Electrophysiology. Adv. Sci.
20. Ha, T., Tran, J., Liu, S., Jang, H., Jeong, H., Mitbander, R., Huh, H., Qiu, Y., Duong, J., Wang, R.L., et al. (2019). A Chest-Laminated Ultrathin and Stretchable E-Tattoo for the Measurement of Electrocardiogram, Seismocardiogram, and Cardiac Time Intervals. Adv. Sci.
21. Shustak, S., Inzelberg, L., Steinberg, S., Rand, D., David Pur, M., Hillel, I., Katzav, S., Fahoum, F., De Vos, M., Mirelman, A., et al. (2019). Home monitoring of sleep with a temporary-tattoo EEG, EOG and EMG electrode array: A feasibility study. J. Neural Eng.
22. Lipomi, D.J., and Bao, Z. (2011). Stretchable, elastic materials and devices for solar energy conversion. Energy Environ. Sci. 4, 3314-3328.
23. Li, W., Kerr, E., Goulet, M., Fu, H., Zhao, Y., Yang, Y., Veyssal, A., He, J., Gordon, R.G., Aziz, M.J., et al. (2019). A Long Lifetime Aqueous Organic Solar Flow Battery. Adv. Energy Mater. 1900918, 1-8.
24. Pang, S., Gao, Y., and Choi, S. (2018). Flexible and Stretchable Biobatteries: Monolithic Integration of Membrane-Free Microbial Fuel Cells in a Single Textile Layer. Adv. Energy Mater. 8, 1-8.
25. Siddiqui, S., Lee, H.B., Kim, D. Il, Duy, L.T., Hanif, A., and Lee, N.E. (2018). An Omnidirectionally Stretchable Piezoelectric Nanogenerator Based on Hybrid Nanofibers and Carbon Electrodes for Multimodal Straining and Human Kinematics Energy Harvesting. Adv. Energy Mater. 8, 1701520.
26. Parvez Mahmud, M.A., Huda, N., Farjana, S.H., Asadnia, M., and Lang, C. (2018). Recent advances in nanogenerator-driven self-powered implantable biomedical devices. Adv. Energy Mater. 8, 1701210.
27. Lamberti, A., Clerici, F., Fontana, M., and Scaltrito, L. (2016). A Highly Stretchable Supercapacitor Using Laser-Induced Graphene Electrodes onto Elastomeric Substrate. 1-6.
28. Zhang, Z., Wang, L., Li, Y., Wang, Y., Zhang, J., Guan, G., Pan, Z., Zheng, G., and Peng, H. (2017). Nitrogen-doped core-sheath carbon nanotube array for highly stretchable supercapacitor. Adv. Energy Mater. 7, 1601814.
29. Zamarayeva, A.M., Ostfeld, A.E., Wang, M., Duey, J.K., Deckman, I., Lechêne, B.P., Davies, G., Steingart, D.A., and Arias, A.C. (2017). Flexible and stretchable power sources for wearable electronics. 1-11.
30. Song, W., Kong, M., Cho, S., Lee, S., Kwon, J., Son, H. Bin, Song, J.H., Lee, D., Song, G., and Lee, S. (2020). Stand-alone intrinsically stretchable electronic device platform powered by stretchable rechargeable battery. Adv. Funct. Mater. 30, 2003608.
31. Liu, W., Chen, Z., Zhou, G., Sun, Y., Lee, H.R., Liu, C., Yao, H., Bao, Z., and Cui, Y. (2016). 3D porous sponge-inspired electrode for stretchable lithium-ion batteries. Adv. Mater. 28, 3578-3583.
32. Zamarayeva, A.M., Gaikwad, A.M., Deckman, I., Wang, M., Khau, B., Steingart, D.A., and Arias, C. (2016). Fabrication of a High-Performance Flexible Silver-Zinc Wire Battery.
33. Kay, R., and Desmulliez, M. (2012). A review of stencil printing for microelectronic packaging. Solder. Surf. Mt. Technol.
34. Zheng, Y., An, Z., Smyrek, P., Seifert, H.J., Kunze, T., Lang, V., Lasagni, A.-F., and Pfleging, W. (2016). Direct laser interference patterning and ultrafast laser-induced micro/nano structuring of current collectors for lithium-ion batteries. In Laser-based Micro-and Nanoprocessing X (International Society for Optics and Photonics), p. 97361B.
35. Ventrapragada, L.K., Creager, S.E., Rao, A.M., and Podila, R. (2019). Carbon nanotubes coated paper as current collectors for secondary Li-ion batteries. Nanotechnol. Rev. 8, 18-23.
36. Lee, J.M., Choi, C., Kim, J.H., Andrade, M.J. De, Baughman, R.H., and Kim, S.J. (2018). Biscrolled Carbon Nanotube Yarn Structured Silver-Zinc Battery. 1-8.
37. Li, C., Zhang, Q., Songfeng, E., Li, T., Zhu, Z., He, B., Zhou, Z., Man, P., Li, Q., and Yao, Y. (2019). An ultra-high endurance and high-performance quasi-solid-state fiber-shaped Zn-Ag20 battery to harvest wind energy. J. Mater. Chem. A Mater. energy Sustain. 7, 2034-2040.
38. Ho, C.C., Murata, K., Steingart, D.A., Evans, J.W., and KWright, P. (2009). A super ink jet printed zinc-silver 3D microbattery. J. Micromechanics Microengineering 19.
39. Gaikwad, A.M., Zamarayeva, A.M., Rousseau, J., Chu, H., Derin, I., and Steingart, D.A. (2012). Highly stretchable alkaline batteries based on an embedded conductive fabric. Adv. Mater. 24, 5071-5076.
40. Berchmans, S., Bandodkar, A.J., Jia, W., Ram, J., Meng, Y.S., and Wang, J. (2014). An epidermal alkaline rechargeable Ag-Zn printable tattoo battery for wearable electronics †. 15788-15795.
41. Kumar, R., Shin, J., Yin, L., You, J., Meng, Y.S., and Wang, J. (2017). All-printed, stretchable Zn-Ag20 rechargeable battery via hyperelastic binder for self-powering wearable electronics. Adv. Energy Mater. 7, 1602096.
42. Yan, C., Wang, X., Cui, M., Wang, J., Kang, W., Foo, C.Y., and Lee, P.S. (2014). Stretchable Silver-Zinc Batteries Based on Embedded Nanowire Elastic Conductors. 1-6.
43. Liu, H., Zou, Y., Tao, L., Ma, Z., Liu, D., Zhou, P., Liu, H., and Wang, S. (2017). Sandwiched thin-film anode of chemically bonded black phosphorus/graphene hybrid for lithium-ion battery. Small 13, 1700758.
44. Scharf, J., Yin, L., Redquest, C., Liu, R., Quinn, X.L., Ortega, J., Wei, X., Wang, J., Doux, J.M., and Meng, Y.S. (2021). Investigating Degradation Modes in Zn-AgO Aqueous Batteries with In Situ X-Ray Micro Computed Tomography. Adv. Energy Mater.
45. Onoue, T., Araki, K., Ishida, N., Kitamura, T., Niitsu, Y., Yanagisawa, M., Sakamoto, R., and Sato, F. (1995). U.S. Pat. No. 5,462,821A. Gallium based active material for the negative electrode, a negative electrode using the same, and batteries using said negative electrode.
46. Ding, Y., Guo, X., and Yu, G. (2020). Next-generation liquid metal batteries based on the chemistry of fusible alloys. ACS Cent. Sci. 6, 1355-1366.
47. Guo, X., Ding, Y., Xue, L., Zhang, L., Zhang, C., Goodenough, J.B., and Yu, G. (2018). A self-healing room-temperature liquid-metal anode for alkali-ion batteries. Adv. Funct. Mater. 28, 1804649.
48. Wu, Y., Huang, L., Huang, X., Guo, X., Liu, D., Zheng, D., Zhang, X., Ren, R., Qu, D., and Chen, J. (2017). A room-temperature liquid metal-based self-healing anode for lithium-ion batteries with an ultra-long cycle life. Energy Environ. Sci. 10, 1854-1861.
49. Yang, W., Zhang, X., Tan, H., Yang, D., Feng, Y., Rui, X., and Yu, Y. (2021). Gallium-based anodes for alkali metal ion batteries. J. Energy Chem. 55, 557-571.
50. Liu, D., Su, L., Liao, J., Reeja-Jayan, B., and Majidi, C. (2019). Rechargeable Soft-Matter EGaln-MnO2 Battery for Stretchable Electronics. Adv. Energy Mater. 9, 1902798.
51. Liu, G., Kim, J.Y., Wang, M., Woo, J., Wang, L., Zou, D., and Lee, J.K. (2018). Soft, Highly Elastic, and Discharge-Current-Controllable Eutectic Gallium-Indium Liquid Metal-Air Battery Operated at Room Temperature. Adv. Energy Mater. 8, 1703652.
52. Guo, X., Bae, J., Ding, Y., Zhang, X., and Yu, G. (2021). Liquid Alloy Enabled Solid-State Batteries for Conformal Electrode-Electrolyte Interfaces. Adv. Funct. Mater. 31, 2010863.
53. Ford, M.J., Patel, D.K., Pan, C., Bergbreiter, S., and Majidi, C. (2020). Controlled Assembly of Liquid Metal Inclusions as a General Approach for Multifunctional Composites. Adv. Mater. 32, 2002929.
54. Dobbelaere, T., Vereecken, P.M., and Detavernier, C. (2017). A USB-controlled potentiostat/galvanostat for thin-film battery characterization. HardwareX 2, 34-49.
55. Hsieh, Y.C., Chou, S.P., and Moo, C.S. (2004). Balance discharging for series-connected batteries. In PESC Record-IEEE Annual Power Electronics Specialists Conference.

1. A composite electrode comprising polymer with carbon particles percolated by gallium or a gallium-indium alloy.

2. A composite electrode according to the previous claim wherein the carbon: gallium ratio in the polymer is 0.5% to 20%, preferably 1% to 5%, for percolating between gallium.

3. A composite electrode according to any of the previous claims, wherein the gallium is in form of microdroplets, ranging from 0.1 μm to 1000 μm.

4. A composite electrode according to any of the previous claims wherein the polymer is selected from a group of silicones, polyurethanes, styrene block copolymer, or mixtures thereof.

5. A composite electrode according to any of the previous claims wherein the amount of polymer is 2-20% weight percent of a composite, preferably 4-9%.

6. A composite electrode according to any of the previous claims wherein the carbon is in the form of nanoparticle or microparticles and the carbon is selected from carbon black, carbon nanowires, graphene quantum dots or graphene oxide.

7. A composite electrode according to any of the previous claims wherein the polymer is styrene-isoprene-styrene block copolymer.

8. A composite electrode according to the previous claim wherein the gallium is embedded in the styrene-isoprene-styrene.

9. A composite electrode comprising a gallium, carbon, and styrene-isoprene-styrene block copolymer (Ga—C—SIS) and an anode current collector.

10. A composite electrode according to any of the previous claims wherein the composite electrode is a sinter-free electrode.

11. Anode electrode comprising the electrode according to any of the claims 1 to 10.

12. A stretchable battery comprising:
a cathode electrode comprising silver oxide and styrene-isoprene block copolymer (Ag₂O-SIS) and a cathode current collector;
an anode electrode according to the previous claim and an anode current collector;
wherein each of the cathode current collector and anode current collector comprise:
a first current collector of a composite comprising liquid metal eutectic gallium-indium (EGaln), silver (Ag), and styrene-isoprene block copolymer (SIS); and
a second current collector a second layer of carbon black (CB) and styrene-isoprene block copolymer (SIS).

13. A stretchable battery according to the previous claim wherein each of the electrodes is arranged over the respective current collector.

14. A stretchable battery according to any of the claims 12-13 wherein the second current collector is arranged over the first collector for protecting the first current collector from chemical corrosion by an electrolyte.

15. A stretchable battery according to any of the previous claims 12-14 wherein the printable battery further comprises an electrolyte.

16. A stretchable battery according to any of the previous claims 14-15 wherein the electrolyte comprises a gel or a hydrogel selected from PAAM-Aliginate or equivalent, soaked into the electrolyte.

17. A stretchable battery according to any of the previous claims 14-16 wherein the electrolyte is KOH.

18. A stretchable battery according to any of the previous claims 12-17 wherein the anode electrode is arranged such that the Ga-C-SIS gallium particles in the composite self-feed to the surface of the electrode at interface with the electrolyte and aggregate to larger particles.

19. A stretchable battery according to any of the previous claims 12-18 wherein each of the cathode current collector and the anode current collector and the anode and the cathode comprise an elastic binder.

20. A stretchable battery according to the previous claim 12-19 wherein the elastic binder is selected from a list of silicones, polyurethane, block copolymers or equivalent elastomers.

21. A stretchable battery according to any of the previous claims 12-20 wherein the ratio of eutectic gallium-indium (EGaln): silver (Ag): styrene-isoprene block copolymer (SIS) of the first current collector of each of the cathode current collector and anode current collector is 0.65:1:0.65.

22. A stretchable battery according to any of the previous claims 12-21 wherein each first current collector and second current collector of the cathode and the anode, has a thickness from 10 to 400 μm, preferably 20 to 300 μm, preferably from 50 to 200 μm, more preferably from 90 μm to 130 μm.

23. A stretchable battery according to any of the previous claims 12-22 wherein the thickness of each anode electrode and cathode electrode is from 50 to 1000 μm, preferably from 100 to 500 μm.

24. A stretchable battery according to any of the previous claims 12-23 further comprising a film as a seal, preferably the film is selected from a list of thermoplastic polyurethane, Styrenic block copolymer, silicones or equivalent.

25. A stretchable battery according to any of the previous claims 12-24 wherein the battery is printable, in particular the anode, the cathode and the respective current collectors are printable.

26. Electronic circuit comprising stretchable conductive traces of a composite comprising liquid metal eutectic gallium-indium (EGaln), silver (Ag), and styrene-isoprene block copolymer (SIS), and the battery according to any of the previous claims 12-25.

27. A textile comprising the stretchable battery according to any of the previous claims 12-26.

28. Method for obtaining the electrode of any of the claims 1-10, by adding of a block copolymer solution in a solvent, and carbon black with subsequent mixing; melting an amount of gallium and adding it to the mixture, and mixing.

29. Method according to the previous claim further comprising the step of depositing the anode electrode over the second current collector of the anode current collector.

30. Method according to any of the previous claims 28-29, wherein the final ratio between carbon and gallium is 0.5% to 20%, preferably 1% to 5%.

31. Method according to any of the claims 29-30 wherein the deposition is performed through digital printing, extrusion printing, or 3D printing.

32. Method to obtain the stretchable battery according to any of the previous claims 12-24 comprising the following steps:
obtaining the first current collector of each cathode current collector and anode current collector by mixing 20 wt % of styrene-isoprene solution in Toluene with silver flakes in 1:0.65 weight ratio for 3 min at the 2000 rpm and adding liquid metal eutectic gallium-indium and mixing for 3 min at 2000 rpm;
printing the first current collector of each cathode current collector and anode current collector in a substrate;
obtaining the second current collector of each cathode current collector and anode current collector by adding the carbon to 20% styrene-isoprene solution in 1:9 weight ratio, and mixing for 3 min at 2000 rpm, preferably the carbon is carbon black;
printing the second current collector of each cathode current collector and anode current collector an arrange over the first current collector;
obtaining the cathode electrode by adding carbon powder to 20% of styrene-isoprene solution, mixing for 3 min at 2000 rpm and adding Ag₂O with an additional mixing period of 3 min at 2000 rpm;
depositing the cathode electrode over the second current collector of the cathode current collector;
obtaining the anode electrode by adding 20% (wt) SIS solution to carbon black with subsequent mixing for 3 min at 2000 rpm; adding an amount of toluene and mixing at 2000 rpm; melting an amount of Ga and mixing for 3 min at 2000 rpm;
depositing the anode electrode over the second current collector of the anode current collector.

33. Method according to the previous claim wherein the printing is digital printing, selected from extrusion printing, direct ink writing, and/or 3D printing.

34. Method according to any of the previous claims 32-33 comprising the step of encapsulating with a TPU film.
